(19) United States
(12) Patent Application Publication
(10) Pub. No.: US 2015/0321752 A1
(43) Pub. Date: Nov. 12, 2015

(54) VIBRATION DAMPING DEVICES, SYSTEMS, AND METHODS FOR AIRCRAFT

(71) Applicants: Michael W. TRULL, (US); Michael D. JANOWSKI, (US); Andrew D. MEYERS, (US); LORD CORPORATION, Cary, NC (US)

(72) Inventors: Michael W. TRULL, Apex, NC (US); Michael D. JANOWSKI, Clayton, NC (US); Andrew D. MEYERS, Apex, NC (US)

(21) Appl. No.: 14/441,993

(22) PCT Filed: Nov. 22, 2013
(86) PCT No.: PCT/US2013/071427

§ 371 Date: May 11, 2015

Related U.S. Application Data
(60) Provisional application No. 61/784,220, filed on Mar. 14, 2013.
(60) Provisional application No. 61/730,759, filed on Nov. 28, 2012.

(51) Int. Cl. B64C 27/00; F16F 15/22

(52) U.S. Cl. CPC B64C 27/001; F16F 15/223; B64C 2027/004

(57) ABSTRACT

Improved vibration damping devices (10), systems, and related methods are provided herein. In some aspects, damping devices and related methods can be used in single rotor or tandem rotor aircraft. In some aspects, a vibration damping device (10) for use in a vibration damping system of an aircraft can include a housing (10), at least two imbalance masses (42b, 44b) provided in a side-by-side configuration within the housing, and at least two more imbalance masses (40b, 46b) provided in a nested configuration within the housing. In some aspects, devices, systems, and methods include rotating any two imbalance masses provided within the housing in a same direction. Such rotation can result in a linear force for counteracting vibration occurring within the aircraft. In some aspects, devices described herein can include one or more processors for executing commands from a controller within a damping system.

### CROSS REFERENCE TO RELATED APPLICATION

This application relates to and claims priority to U.S. Provisional Patent Application Ser. Nos. 61/730,759, filed Nov. 28, 2012; and 61/784,220, filed on Mar. 13, 2013, the disclosures of which are fully incorporated herein by reference, in their entireties.

### TECHNICAL FIELD

The present subject matter relates generally to vibration damping devices, systems, and methods which can be used to control vibration within an aircraft. More particularly the present subject matter relates to a nested force generator (FG) comprised of at least two side-by-side circular force generator (CFG) devices, systems, and related methods for improved vibration control within an aircraft.

### BACKGROUND

Any structure subjected to vibration is susceptible to fatigue and wear damage from those vibrations. Similarly, any person subjected to vibration is susceptible to fatigue and injury. Vibration control has been attempted in numerous situations to minimize the impact on the structure and/or person. Unfortunately, the various devices are commonly bulky, heavy, loud, limited in range and/or impractical for the situation. To minimize the numerous situations where vibrations are experienced by a structure or person, and are good candidates for vibration control, the non-limiting example of a rotary aircraft is used herein. The problems and solutions apply in similar forms to any rotary aircraft, propeller-driven aircraft, jet aircraft, vehicles, engines, transmissions, buildings, structures and industrial equipment.

Using the non-limiting example of an aircraft, it is noted that various types of aircraft experience vibrations during operation. Such vibrations are particularly troublesome in rotary winged aircraft, such as helicopters (single rotor or tandem rotor), as vibrations transmitted by large rotors can contribute to fatigue and wear on equipment, materials, and occupants within the aircraft. Vibrations can damage the actual structure and components of the aircraft, as well as contents disposed within the aircraft. This can increase costs associated with maintaining and providing rotary winged aircraft, such as costs associated with inspecting and replacing parts within the aircraft, which may become damaged during vibration.

One conventional method of controlling vibration within an aircraft includes using self-tuning vibration absorber (STVA) devices positioned below the pilot and copilot seats to control cockpit vibrations. STVAs are spring-mass systems using a linear motor and a linkage to change the effective moving mass in a linear, vertical direction. In addition to adding large amounts of weight to an aircraft, STVAs are inefficient and slow to respond to changes in rotor rotation frequency (e.g., rpm).

Another problem associated with STVA devices is that masses used with the devices must continually retune according changes in frequency of vibration, even small changes occurring at steady state flight conditions. This causes vibration levels to vary as the STVAs continually retune. In addition, STVAs reach a physical limit or “bottom out” by hitting a hard stop resulting in higher vibration levels.

Accordingly, there is a need for improved vibration damping devices, systems, and methods for controlling vibrations in single and/or tandem rotor aircraft.

### SUMMARY

In accordance with the disclosure provided herein, novel and improved vibration damping devices, systems, and related methods are provided. Notably, vibration damping devices, systems, and related methods described herein can comprise a design utilizing a pair of side-by-side imbalance masses used in combination with a pair of nested imbalance masses. Any two of the four total imbalance masses can rotate in a same direction to minimize, cancel, and/or eliminate vibration within an aircraft, such as within a rotary winged aircraft. Devices, systems, and related methods described herein are advantageous as they require less power, weigh less, utilize smaller bearings, have an increased wear resistance, and can be manufactured at a lower cost than conventional devices and/or systems. It is, therefore, an object of the present disclosure to provide vibration damping devices, systems, and methods having improved performance, in one aspect, by utilizing smaller bearings, similar materials for improved thermal expansion, and nested imbalance masses.

In one aspect a vibration damping device is provided. The vibration damping device comprises: a housing, at least two imbalance masses provided in a side-by-side configuration within the housing, and at least two more imbalance masses provided in a nested configuration within the housing. Wherein, any two imbalance masses within the housing are paired to rotate together in a same direction according to a desired vibration canceling force.

In another aspect a vibration damping system for use in an aircraft is provided. The vibration damping system comprises a plurality of sensors, a controller and a vibration damping device. The plurality of sensors are disposed within a plurality of locations about the aircraft for measuring vibration data. The controller is electrically communicating with the plurality of sensors receiving the vibration data and sending a force command to a vibration damping device. The vibration damping device electrically communicating with the controller, wherein the vibration damping device includes: a housing, an electronics enclosure provided at one end of the housing, multiple electric motors provided within the housing, and a processor disposed within the electronics enclosure for controlling and monitoring an electrical current supplied to the multiple electric motors.

In another aspect, a method of damping vibration within an aircraft is provided. The method comprising the steps of:
(a) detecting vibration within the aircraft;
(b) generating and sending a force command to multiple force generators, wherein each force generator includes:
   (i) a housing;
   (ii) at least two imbalance masses provided in a side-by-side configuration within the housing: and
   (iii) at least two imbalance masses provided in a nested configuration within the housing; and
(c) rotating any two imbalance masses within the housing in a same direction about a shaft to counteract the vibration within the aircraft.

In another aspect a vibration damping system is provided. The vibration damping system comprises a plurality of sensors, a controller and a vibration damping device. The controller is electrically communicating with the plurality of sensors. The vibration damping device is electrically communicating with the controller, wherein the vibration damping device includes: a housing, an electronics enclosure provided at one end of the housing, multiple electric motors provided within the housing, and a processor disposed within the electronics enclosure for controlling and monitoring an electrical current supplied to the multiple electric motors.

These and other objects of the present disclosure as can become apparent from the disclosure herein are achieved, at least in whole or in part, by the subject matter disclosed herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIGS. 1 and 2 are perspective views of a vibration damping device according to one aspect of the subject matter described herein;

FIGS. 3A and 3B are sectional views of a vibration damping device according to one aspect of the subject matter described herein;

FIG. 4 is a block diagram illustrating a vibration damping system according to one aspect of the subject matter described herein;

FIG. 5 is a schematic diagram of a rotary winged aircraft including vibration damping devices and systems according to one aspect of the subject matter described herein; and

FIGS. 6 and 7 are graphical representations of force and power configuration of vibration damping devices and systems according to one aspect of the subject matter described herein.

### DETAILED DESCRIPTION

The subject matter described herein is directed to novel vibration damping devices, systems, and methods for use and installation within a rotary winged aircraft. In some aspects, novel vibration damping devices, systems, and methods can comprise a hybrid or nested imbalance mass configuration utilized alone and/or in combination with a side-by-side imbalance mass configuration. In some aspects, vibration damping devices described herein can comprise a nested force generator (i.e., a nested FG).

In some aspects, vibration damping devices, systems, and methods described herein can comprise at least two (2) nested imbalance masses. In other aspects, vibration damping devices, systems, and methods herein can comprise at least two (2) side-by-side imbalance masses within. As used herein, the term “nested” refers to components having a nested fit or a nested configuration, where one component is at least partially enclosed within and/or closer to a shaft of a rotating device with respect to another component. In some aspects, vibration damping devices can have both nested imbalance masses and side-by-side imbalance masses disposed therein. In some aspects, each imbalance mass can be physically separated from other imbalance masses.

Vibration damping devices, systems, and methods described herein can comprise to provide at least two (2) circular force generators (CFGs) spinning in opposite directions to create linear forces. In other aspects, any two imbalance masses of the four total imbalance masses can spin in a same direction, i.e. the two inner imbalance masses (the pair of side-by-side masses), the two nested imbalance masses, or one inner and one outer (nested) imbalance masses can spin in a same direction. This can advantageously result in balancing lower moments and reduced production costs.

In some aspects, vibration damping devices, systems, and methods can reduce roll and yaw moments by at least a factor of three (3) over conventional designs. In some aspects, vibration damping devices, systems, and methods described herein can advantageously produce low moments at a higher force density.

Vibration damping devices, systems, and methods comprise smaller bearings compared to conventional devices. Such bearings can be press fit on or about portions of a shaft and/or rotor frames to reduce any differential in thermal expansion. Moreover, the shaft, rotor, bearings, and/or portions thereof can be fabricated out of materials having a same or similar coefficient of thermal expansion (CTE). This can be advantageous for both improving wear and reducing fatigue. In some aspects, such components are fabricated from a similar steel material or alloy, a similar aluminum (Al) material or alloy, or any other similar materials or metals having similar CTEs. In some aspects, these bearings, which can be press fit on steel shaft or rotors, improve wear fatigue and allow for smaller internal clearances. In some aspects, the improved bearings are disposed on or about a centerline shaft. This results in a lowered drag torque, which results in reduced power requirements and a reduced motor size.

Vibration damping devices, systems, and methods described herein reduce low yaw moments from approximately 6000 in-lb to approximately 1500 in-lb or less (FIG. 6), and also reduce low roll moments from approximately 3000 in-lb to approximately 800 in-lb or less. In some aspects, devices, systems, and/or methods described herein comprise a force density (i.e., force output/weight) which can increase to approximately 31 lb/lb.

As known to those skilled in the art, CFGs are configured to create circular forces. Vibration damping devices, systems, and methods described herein utilize at least two CFGs or portions of two CFGs spinning in opposite directions for creation of linear forces. In some aspects, any two rotors of two side-by-side CFGs are paired to spin in a same direction (i.e. the two inner rotors or one inner and one outer (nested).

Vibration damping devices, systems, and methods described herein comprise multiple drive motors disposed within a housing or housings of the device. The drive motors control movement, position, and/or rotation of the imbalance masses within the vibration damping device by increasing and decreasing an electrical current or electrical power supply.

An electronics enclosure can be co-located within vibration damping devices provided herein. This provides for electromagnetic interference (EMI) protection, while reducing an amount of shielding required. The reduced EMI shielding lowers the overall system weight.

The electronics enclosure of vibration damping devices described herein includes a power interface and communications input and output. The power interface receives power from the rotary winged aircraft power, for example, directly from a generator. In the non-limiting example of an aircraft, the aircraft engines (e.g., transmission(s)) can transmit power to and/or drive a generator, which in turn, transmit power to the force generators FGs or CFGs. The power interface can be configured to provide electrical power to the drive motor(s) within the device. The electronics package or enclosure can comprise a communications input and a communications output.

The electronics enclosure can house a processor configured to receive a force command as input from a controller, and execute software for generating the vibration cancelling force via rotation of imbalance masses. The force generation command is executed via a processor, and controls an amount of vibration per device provided via rotation and/or position of imbalance masses and corresponding rotors. The processor further controls an amount of power and/or drive frequency provided to one or more drive motor(s). Commands received from an external controller are communicated or signaled via the communications input and output.

Vibration damping devices, systems, and methods described herein include a plurality of sensors positioned on the system. By way of the non-limiting aircraft example, the vibration damping devices, systems, and methods include at least four (4) sensors positioned about portions of the aircraft for providing a physical parameter input to the communications input and/or a centralized controller. In some aspects, the sensors can comprise accelerometers that electrically communicate with a central controller via a communications input.

As described herein, a system of at least one nested FG (e.g., comprised of two CFGs) can be expanded to include at least six (6) nested FGs up to any number of nested CFGs the electronic communications systems can support. Vibration damping devices, systems, and methods can comprise at least four (4) sensors and at least ten (10) spare sensor channels.

A load path associated with devices or systems described herein includes transferring a load from an imbalance mass, to a rotor, to a bearing, to a shaft, to a housing of the vibration damping device, to a mounting plate, to a structure such as an aircraft. Using lower cost bearings offsets any cost associated with providing a nested imbalance design.

Vibration damping devices and systems described herein provide a higher force density from a smaller footprint device. Using a Hall sensor provided about a centerline shaft precludes the use of a rotary encoder. Thus, to determine rotor position, the at least one Hall sensor is provided proximate portions of one or more drive motors. The location of the Hall sensor can be controlled by keying the mechanical components in the nested FG. Precisely locating the Hall sensor within vibration damping devices and/or systems described herein eliminates additional calibration requirements. Elimination of calibration requirements allows software parameters to be hard coded for preventing generation of fore-aft forces which are potentially damaging to the aircraft structure. Thus, vibration damping devices and systems described herein are encoderless.

Vibration damping devices, systems, and related methods utilize electrical current sensing techniques to detect bearing degradation within a device. Electronics disposed within the device monitor an electrical current provided to drive motors. Changes in electrical current to the drive motors provide bearing wear information, and can be used to prevent failure due to bearing wear and degradation.

Improved vibration damping devices, systems, and methods described herein can be configured to monitor vibrations at a plurality of different locations, and “actively” test for structural response changes over time, such as when the system, such as the non-limiting example of an aircraft is initially powered. For example, if the rotary winged aircraft has a particular vibration frequency below 11 Hertz (Hz), the improved system measures the structural response. If the structural response changes significantly over time, this may be an indication of a structural fault (e.g., such as in an aft gear box location where there may be a known structural fatigue issue). This type of data can be useful in making sure that the rotary winged aircraft continues to fly safely, and provides useful information to determine when structural modifications are necessary.

Devices, systems, and related methods described herein can include a centralized computer or centralized controller configured to received data from the damping devices and/or sensors (e.g., accelerometers), calculate appropriate force commands for each vibration damping device, and simultaneously communicate those commands to the co-located electronics packages disposed within each vibration damping device. The electronic communications can be a direct linked or wirelessly linked to the vibration damping devices.

In the non-limiting example of an aircraft, the vibration levels within the aircraft can be measured or detected by sensors (e.g., accelerometers). The vibration data is be forwarded to and/or processed by the centralized computer or controller of a vibration damping system, consisting of hardware and software. The controller interprets the signals and sends force generation commands to multiple vibration damping devices comprising force generators (FGs) (e.g., nested FGs) located throughout the aircraft. The FGs create an “anti-vibration” effect that minimizes or eliminates the progression of vibration from a main rotor or tandem rotors.

Vibration damping devices, systems, and methods described herein can provide drop-in replacement devices adapted to provide superior vibration control at significantly reduced weight and reduced dimensions (e.g., length and/or width). The weight can be reduced by 160+ pounds over conventional vibration damping devices and systems. That is, vibration damping devices described herein can weigh approximately 20 pounds or more, approximately 50 pounds or more, or approximately 80 pounds or more. Vibration damping devices described herein can weight less than approximately 100 pounds. The weight of the force generator is dependent on force output requirement, which may include a N/rev frequency.

Vibration damping devices, systems, and methods described herein provide active, as opposed to passive vibration control. In the non-limiting example of a rotary wing aircraft, this allows for improved compensation for the complex dynamics of helicopter structures, optimum vibration cancellation for all flight conditions (e.g., steady state, transient), and the superior ability to track changes in rotor speed.

Continuing with the non-limiting example of a rotary wing aircraft, vibration damping devices, systems, and methods described herein include mounting one or more devices on the rotor(s) and/or proximate the rotor head(s) of the aircraft. With this approach, the ability to control or suppress vibration is moved closer to the vibration source for cancelling vibration originating at rotor blades at a blade-pass frequency. Devices, systems, and methods described herein reduce weight, eliminate vibration, and deliver a smoother helicopter ride across a multiple configuration of missions and roles.

As used herein, the term “controller” refers to software in combination with hardware and/or firmware for implementing features described herein. In some aspects, a controller may include a memory, a processor, a field-programmable gateway array, and/or an application-specific integrated circuit.

For the description hereinafter, the non-limiting example of a rotary aircraft is used to describe the vibration damping devices, systems, and methods.

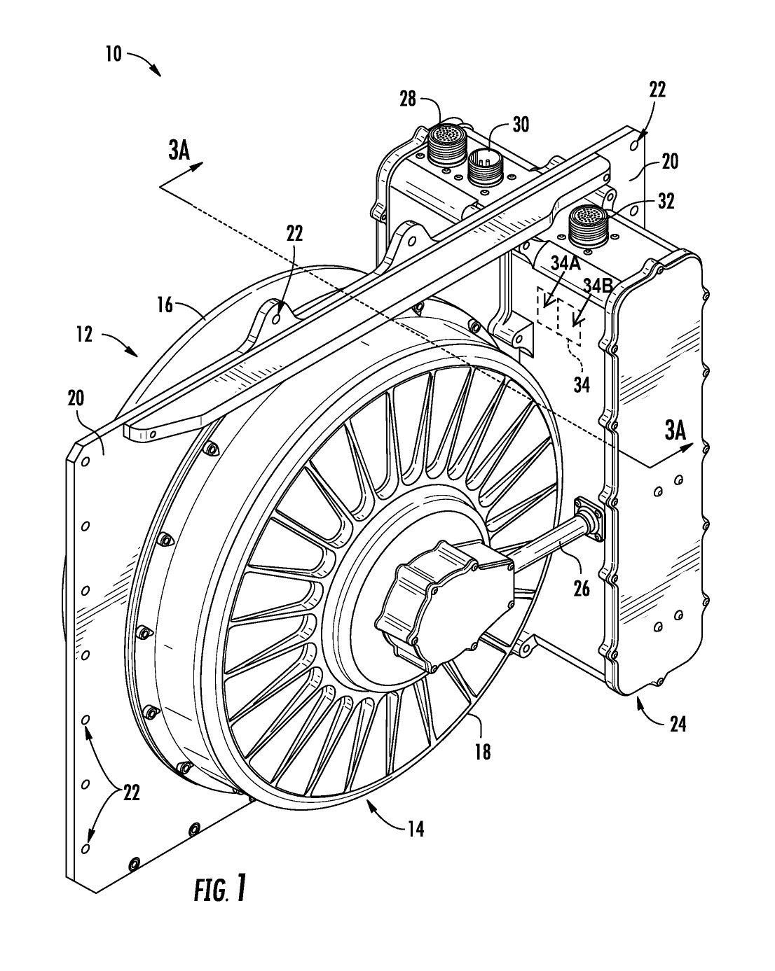

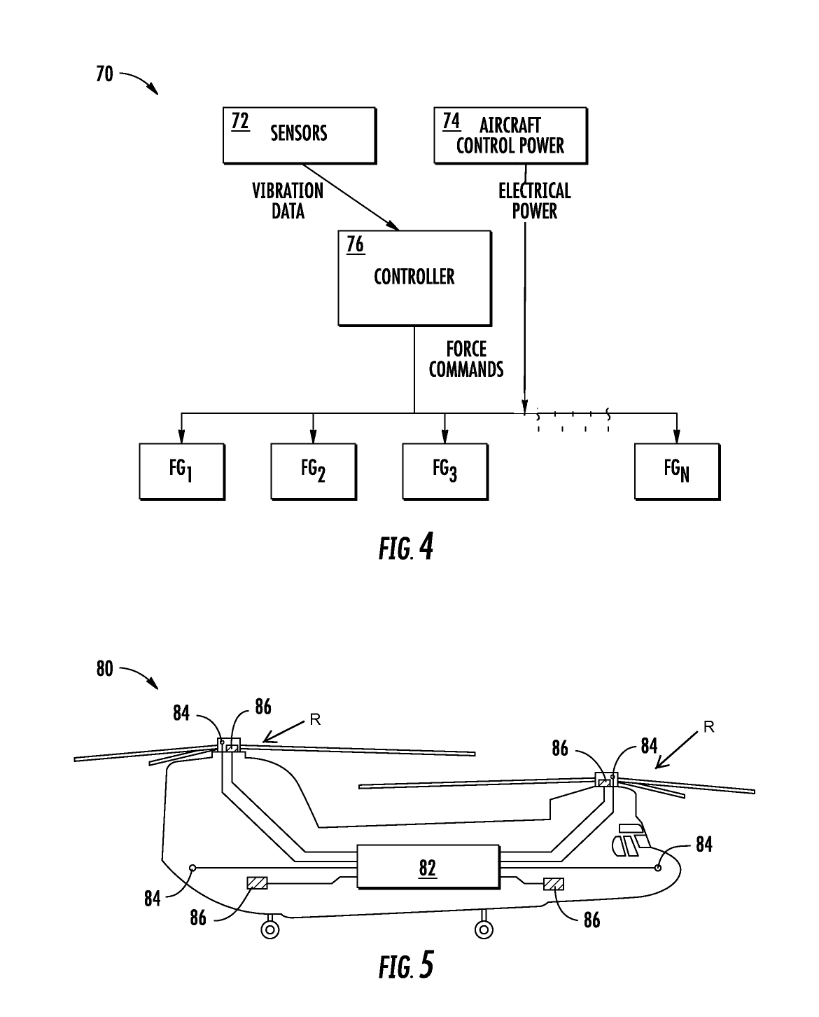

FIGS. 1 to 6 illustrate various views and/or features associated with vibration damping devices and related methods for controlling vibration within an aircraft, namely, within a rotary wing aircraft. In some aspects, vibration damping devices and related methods described herein can be adapted for use in single rotor and/or a tandem rotor aircraft (FIG. 5).

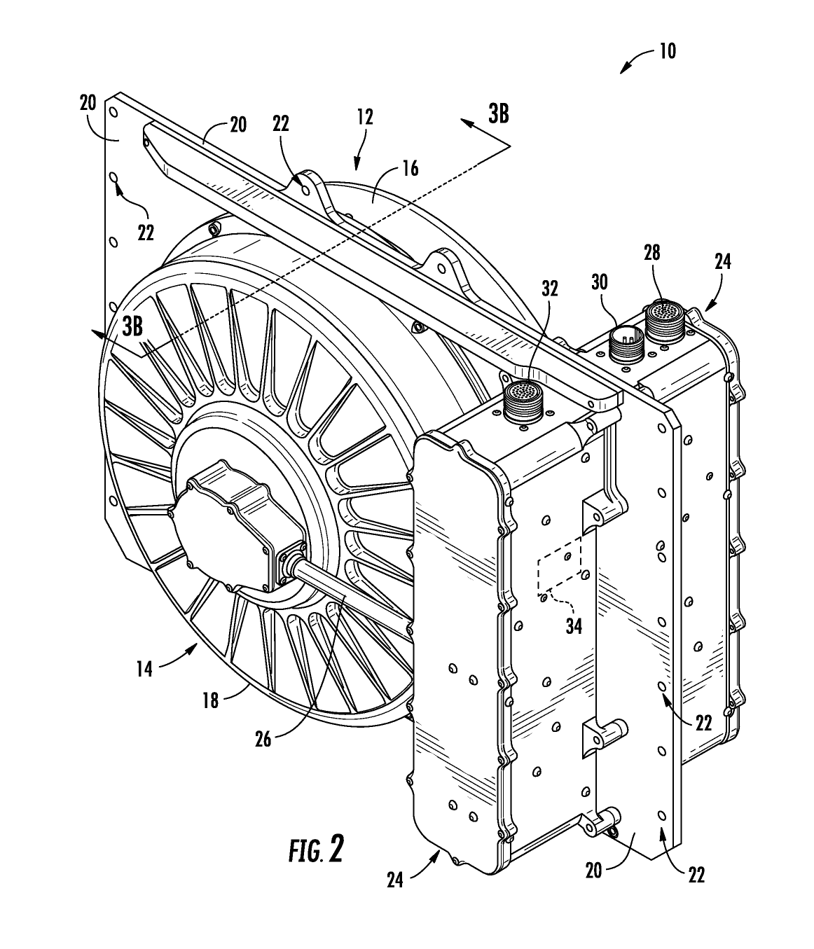

FIGS. 1 and 2 are front and back perspective views of a vibration damping device, generally designated 10 for use in a vibration damping system. In some aspects, device 10 include multiple side-by-side (e.g., nested) circular force generators (CFGs). Device 10 includes a first CFG 12 disposed adjacent to a second CFG 14. First CFG 12 is illustrated as being at least partially disposed within a first housing 16. Second CFG 14 is illustrated as being at least partially disposed within a second housing 18. A mounting plate 20 is illustrated as being disposed between portions of first and second housings 16 and 18, respectively. First and second housings 16 and 18, respectively, are secured to portions of mounting plate 20 via mechanical fasteners, such as screws. However, other forms of fastening may be used.

Mounting plate 20 includes a plurality of apertures 22 which are provided and adapted to receive mechanical fasteners thereby securing device 10 to portions of a rotary winged aircraft frame and/or rotors of the aircraft (e.g., FIG. 5). Mechanical fastening devices can comprise, for example, screws, bolts, nails, rivets, pins, clips, hooks, etc. and are not limited to a particular type or configuration. Notably, apertures 22 can be disposed over multiple surfaces or edges of device 10. For example, apertures can be disposed across portions of both horizontal and vertical edges of device 10, such that device 10 can be affixed in multiple different configurations with respect to the aircraft, and along vertical or horizontal sides, as desired. That is, device 10 is not limited to horizontal or vertical mounting, and can be mounted in various different configurations within an aircraft.

Device 10 further includes an electronics enclosure or housing, generally designated 24. Electronics enclosure 24 can be disposed proximate a first end of the device 10. One or more conduits 26 can optionally provide electrical communication between electronic devices housed within electronics enclosure 24 and portions of the nested CFGs within device 10. Electronics enclosure 24 includes at least one communications input 28 and at least one communicates output 32. In one embodiment, communications input 28 and communications output 32 are bi-directional communication data buses. Co-locating electronics and/or the position thereof reduces the amount of electromagnetic shielding required by reducing the need for additional electromagnetic interference (EMI) shielding. This decreases the weight of device 10 and/or a damping system. Co-locating mechanical and electrical components also minimizes additional hardware (e.g., harnesses, etc.) required when mounting device 10, which further reduces weight.

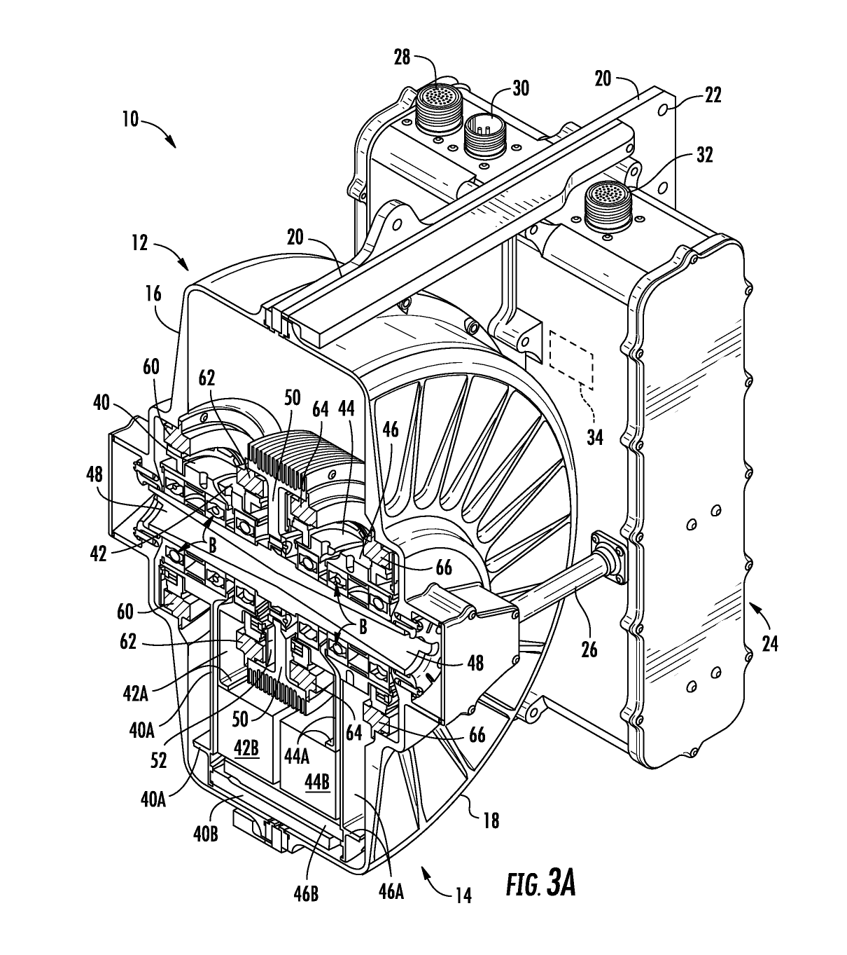

Electronics enclosure 24 further includes a power interface 30. Power interface 30 is configured to receive electronic signal, current or electrical power from the rotary winged aircraft, optionally via a generator (not shown). Electronics enclosure 24 is configurable to receive power transmitted from an engine or engines of the rotary winged aircraft. Power can be transmitted directly or indirectly to enclosure 24 via a generator (not shown). Power interface 30 is configured to receive power from the generator, and provide electrical power to the motors (60 to 66, FIGS. 3A and 3B) housed within device 10. Electrical power can also be transmitted via the one or more conduits 26.

Electronics enclosure 24 further comprises computer hardware including one or more processors 34 and a memory (not shown). In some aspects, electronics enclosure 24 includes computer hardware having at least two processors 34 (e.g., schematically illustrated 34A and 34B) where each processor is configurable to control separate first and second CFGs 12 and 14. Processor(s) 34 are schematically illustrated in phantom lines; as such component(s) may not be visible from outside of device 10. Processor(s) 34 can be configured to control a rotation speed and/or rotation frequency of rotors and/or imbalance masses (FIGS. 3A and 3B) disposed within device 10 for generating vibration canceling forces for cancelling vibration within the aircraft.

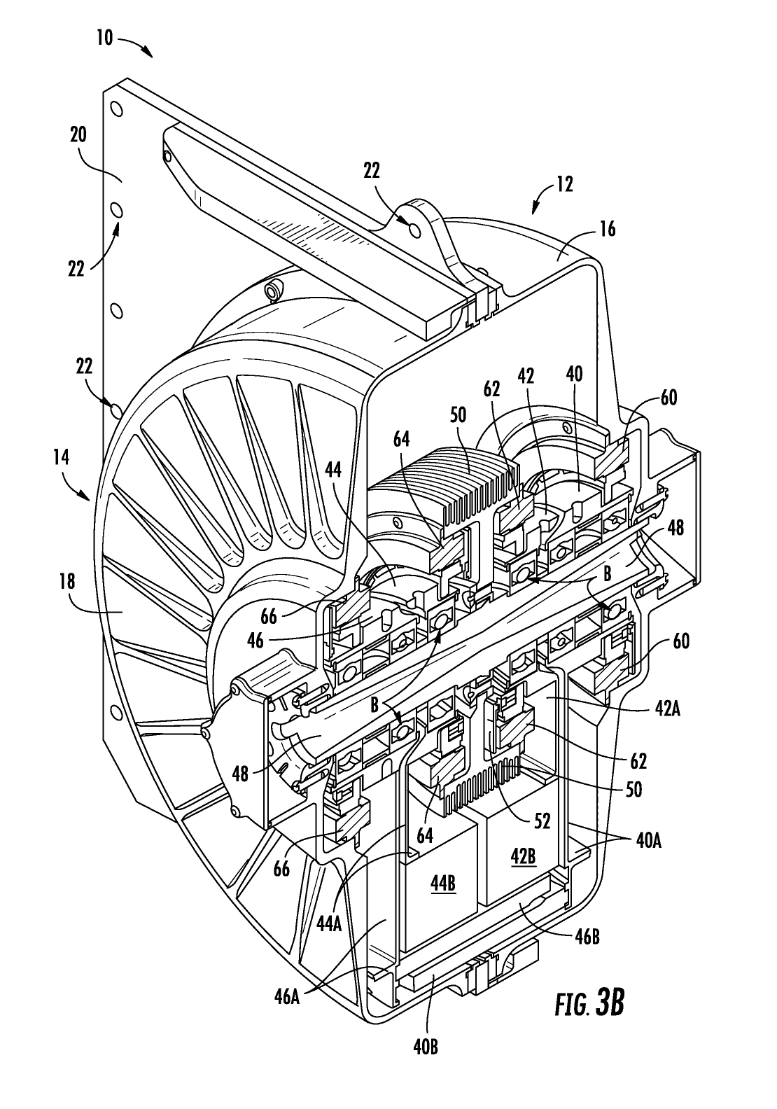

Processor(s) 34 are adapted to control an amount of power transmitted to drive motors of device 10. Processor(s) 34 can be configured to execute software for executing force commands communicated from an external controller (FIG. 4). Software is preferably implemented via a non-transitory computer readable medium having stored thereon computer executable instructions that when executed by processor(s) 34 allow device 10 to generate vibration canceling forces as communicated via a force command or commands from a controller (e.g., FIG. 4). The force or forces generated by one or more devices 10 within an aircraft actively cancel the complex vibration occurring within the aircraft due to the rotating blades and/or rotors of the aircraft. Electronics housed within enclosure 24, namely processor(s) 34, can further be adapted to monitor electrical current provided to various motors within device 10, and/or monitor changes in electrical current which can translate into bearing wear information as discussed further below with respect to FIGS. 3A and 3B.

Device 10 can be adapted to provide a “drop in” replacement for conventional (e.g., less efficient and less effective) vibration damping devices. That is, device 10 can be configured to drop in to and/or become affixed within a desired position upon removal of a conventional device or for retrofitting an aircraft, without requiring additional mounting hardware or electrical communication equipment. This provides for an improved ease of installation and/or improved replacement. Device 10 contributes to a weight savings of approximately 80 pounds or more per device, when replacing conventional devices. That is, devices 10 can weigh approximately 20 pounds or more, approximately 50 pounds or more, or approximately 80 pounds or more. Device 10 can weigh less than approximately 100 pounds or less. This weight savings contributes a significant weight reduction over to conventional devices and/or systems.

Referring to FIGS. 3A and 3B, internal structures associated vibration damping device 10 are shown and described. Multiple imbalance rotors positioned side-by-side, within portions of first and second housings 16 and 18, respectively, are illustrated. A first rotor 40 having a first rotor frame 40A is illustrated directly adjacent to a second rotor 42 having a second rotor frame 42A. First rotor 40 and first rotor frame 40A are at least partially connected to and/or support a first imbalance mass 40B. First rotor 40 rotates the first imbalance mass 40B about portions of a shaft 48. Device 10 can comprise four rotors configured to rotate four imbalance masses about shaft 48. The resulting forces can be linear, have low moments, and be configured to counteract and/or eliminate vibration occurring within an aircraft. The rotation speed or speeds associated with each respective rotor can be controlled via at least one processor 34 housed within enclosure 24. In some aspects, two processors 34 can be disposed within enclosure 24. In this case, a first processor controls first CFG 12 and second processor controls second CFG 14. Each processor 34 can execute a force command or signal received from an external, centralized controller (76, FIG. 4) for controlling at least two motors disposed within device 10. First and second rotors 40 and 42, respectively, can be disposed within first CFG 12 and within first housing 16.

Second rotor 42 can comprise a second rotor frame 42A at least partially connected to and/or supporting a second imbalance mass 42B. A third rotor 44 having a third rotor frame 44A can be provided directly adjacent to a fourth, outermost rotor 46 having a fourth rotor frame 46A. Third rotor 44 and third rotor frame 44A are at least partially connected to and/or support a third imbalance mass 44B. Similarly, fourth rotor 46 and fourth rotor frame 46A can be at least partially connected to and/or support a fourth imbalance mass 46B. Third and fourth rotors 44 and 46, respectively, are disposed within second CFG 14 and within second housing 18 of device 10.

Still referring to FIGS. 3A and 3B, device 10 has a non-rotating portion, such as a stator support 50. Stator support 50 has a support structure retaining stators of inner motors of device 10, such as first through fourth rotors 40, 42, 44, and 46, respectively, and first through fourth imbalance masses 40B, 42B, 44B, and 46B, respectively. First and second rotors 40, 42 are disposed on a first side of stator 50 and third and fourth rotors 44, 46 are disposed on a second, opposing side of stator 50.

Device 10 generates a linear force to cancel or significantly reduce vibration within a rotary winged aircraft. The linear force is generated when rotors and respective masses of first CFG 12 spin in an opposite direction to rotors and respective masses of second CFG 14. Device 10 can be configured to create a linear force when any pair of two imbalance masses 40B, 42B, 44B, and 46B spins in a same direction. That is, any two of the four rotating imbalance masses 40B, 42B, 44B, and 46B can spin in a same direction.

Second and third imbalance masses 42B and 44B, respectively, comprise a first pair of side-by-side masses. First and fourth imbalance masses 40B and 46B comprise a second pair of nested imbalance rotors, as fourth imbalance mass 46B is nested with respect to first imbalance mass 40B. That is, first imbalance mass 40B is disposed about portions of fourth imbalance mass 46B, without physically touching fourth imbalance mass 46B. Fourth imbalance mass 46B can be closer in distance to shaft 48 than first imbalance mass 40B. Each imbalance mass is physically separated from each other imbalance mass. The pair of nested imbalance masses (e.g., 40B, 46B) can be disposed about portions of the side-by-side imbalance masses (e.g., 42B, 44B).

Device 10 is configured to rotate the first pair of imbalance masses (e.g., 42B and 44B) in a same direction. Device 10 can be configured to rotate the second pair of imbalance masses (e.g., 40B and 46B) in a same direction. Device 10 can be configured to rotate any two imbalance masses of the four imbalance masses in a same direction (e.g., such as one side by side mass and one nested mass). That is, the side-by-side masses and the nested masses are paired according to the desired reaction moments. The other two remaining imbalance masses can rotate in a second direction that opposes the direction of the first pair of rotating imbalance masses.

Rotation of any two imbalance masses in a same direction balances lower moments and reduces production costs associated with device 10. Further, nesting at least one imbalance mass with respect to another imbalance mass decreases cost and reduces weight of device 10, as such nested masses weigh less than the side-by-side masses. Nesting imbalance masses also provides a significant increase in a force density output from device 10 while reducing weight (e.g., in part, by allowing smaller weights and smaller motors to be used).

Device 10 can comprise at least one Hall sensor 52 disposed proximate a centerline shaft 48. Hall sensor 52 is configured to provide electronics enclosure 24 position control of rotors and/or imbalance masses within device 10. Hall sensor 52 obviates the need for a rotary encoder for providing position control. This eliminates the need for additional calibration requirements associated with using a rotary encoder. Hall sensor 52 provides position control via keying the mechanical components within device 10, which can allow software parameters executed by one or more processors 34 to be hard coded. This prevents the need for additional calibration, and also prevents generation of fore-aft forces that are potentially damaging to an aircraft structure. Accordingly, devices 10 described herein can be encoderless. This can further allows elimination of any paddle card required by an encoder from being installation within device 10. Providing more than one Hall sensor 54 is also contemplated.

Still referring to FIGS. 3A and 3B, device 10 further includes multiple driver motors. As illustrated, device 10 includes at least four drive motors configured side-by-side for rotating each of the first through fourth rotors 40, 42, 44, and 46, respectively. A first drive motor 60 is configured to supply power to and rotate first rotor 40. For improved visibility and illustration purposes, sectional faces of each motor have been shaded. Drive motors include circular shaped components disposed about shaft 48. A second motor 62 is illustrated as supplying power to and/or rotating second rotor 42. Third and fourth motors 64 and 66, respectively, are provided for supplying power to and/or rotating third and fourth rotors 44 and 46, respectively. First through fourth motors 60 to 66, respectively, are brushless DC motors. Each motor receives electrical current or power from portions of the aircraft which may be via conduits 26 transmitting electrical power received at enclosure 24 (e.g., from a generator).

Rotation of each rotor about shaft 48 is controllable by varying the duty cycle of the supply voltage received from enclosure 24 via each processor 34. First through fourth motors 60 to 66 are configured to control the rotation and/or movement of the imbalance masses within device 10. First through fourth motors 60 to 66, respectively, include variable speed drive motors. Each motor has a stationary portion connected to a stationary portion of device 10 (either stator 50 or a housing of about shaft 48) and a movable portion connected to the respective movable (e.g., rotating) rotor.

Each rotor (e.g., 40 to 46) can be supported upon shaft 48 by one or more antifriction bearings, generally designated B. Bearings B include a small diameter which provides a lowered or reduced drag torque. This reduces power requirements of device 10, and allows for smaller motors. This also contributes to a further savings in weight and production cost. Bearings B have an outer diameter that is approximately 10 mm or more, approximately 20 mm or more, approximately 40 mm or more, or more than approximately 60 mm.

Bearings B can be press fit (e.g., frictionally held) about portions of shaft 48. Bearings B, shaft 48, and/or rotors 40 to 46 are manufactureable from similar materials having a similar coefficient of thermal expansion (CTE). This prevents failures occurring within device 10 because of differing CTE. Bearings B, shaft 48, and/or rotors 40 to 46, or combinations thereof, are preferably fabricated from a similar steel material or alloy, a similar aluminum (Al) material or alloy, or any other similar materials or metals having similar CTEs. This reduces wear fatigue and allows for smaller internal clearances, thereby reducing a footprint or size (and power requirements) of device 10. Device 10 can output an increased force density at a smaller footprint and having increased wear resistance. Device 10 can comprise a force density of approximately 31 lb/lb or more.

Referring to FIG. 5, a load path associated with device 10 transfers the load from imbalance masses 40B to 46B, to rotors 40 to 46, to bearings B, to shaft 48, to housings 16 and 18, to mounting plate 20, and to the aircraft. Bearings B can be susceptible to wear and/or fatigue. To counteract this as noted above, bearings B can be press fit about shaft 48. Bearings B and shaft 48 can also comprise a similar material, such as steel. In addition, and to prevent failure of bearings due to wear and fatigue, each processor 34 disposed within enclosure 24 is adapted to monitor an electrical current provided to drive motors 60 to 66 for monitoring bearing wear information. By monitoring changes in electrical current supplied to the drive motor, bearing wear information can be determined. Thus, bearings are monitored and replaced before failure occurs.

Referring to FIG. 4, a vibration damping system, generally designated 70, is illustrated. System 70 is illustrated as being disposed within an aircraft for eliminating or controlling complex vibrations caused either via single or tandem rotors. In some aspects, system 70 comprises one or more sensors 72 and an aircraft control panel 74. Both sensors 72 and control panel 74 are configured to communicate inputs, information, power, and/or other information to centralized controller 76 and/or FGs. Sensors 72 are provided at various locations about the aircraft (e.g., aircraft frame, proximate rotor(s) and blades, etc.) for measuring and communicating vibration data to controller 76. In some aspects, FGs can be configured to receive AC voltage and convert or rectify the AC voltage to DC voltage. This eliminates weight associated with extra shielding.

Referring to FIGS. 1-3B, FGs can be configured to provide vibration control within a cabin of a rotary aircraft such as a Medevac or Medivac. In this embodiment, FGs are configured to provide vibration control for one or more seats (e.g., pilot and/or copilot seats) of the aircraft. Thus, some of the sensors 72 are positioned in the cabin of the rotary winged aircraft. Other sensors 72 are positioned throughout various locations within the aircraft for measuring and communicating vibration information to controller 76. As illustrated, at least four sensors 72 are positioned throughout various locations within the aircraft for measuring and communicating vibration information to controller 76. Sensors 72 can be accelerometers adapted to measure a speed or frequency of vibration. At least, ten or more sensors or fourteen or more sensors can be provided. The limit to the number of sensors is determined by the ability to electronically communicate the data to the controller(s). For the at least four sensors provided each sensor detects and communicates a physical parameter input to controller 76 for processing and generating force commands.

As FIG. 4 further illustrates, controller 76 configured to generate and send force commands to vibration damping devices, such as force generators (FG) denoted FG₁ to FG_{N} (e.g., where N is an integer >1). Each FG can be similar in form and function to device 10 (FIGS. 1 to 3B). A generator is illustrated and can be adapted to provide electrical power to each FG. Power can be received in an electrical enclosure (e.g., 24, FIGS. 1 to 3B) of each FG and can be communicated to motors and rotors. The communication of the power may be through conduits (e.g., 26, FIGS. 1 and 2). Any number of FGs can be provided in system 70. In the embodiment illustrated, system 70 includes at least two-n FGs. Accordingly, system 70 can comprise two, four, six or more FGs. Systems 70 having more than six FGs are contemplated, depending upon the size, shape, type, and/or mission of the aircraft.

Controller 76 can be configured to monitor vibrations within an aircraft via the plurality of sensors 72 and “actively” test for structural responses to vibration control via damping devices (e.g., 10, FIGS. 1-3B) over time. For example, if the rotary aircraft has a particular vibration frequency below approximately 11 Hz, system 70 can measure the structural response. If the structural response changes significantly over time, this may be an indication of a structural fault (e.g., in an aft gear box location where there may be a structural fatigue issue). This type of data is useful in making sure that the aircraft continues to fly safely, and provides useful information to determine when structural modifications are necessary. Sensors 72 can also be configured to collect data generated by the vibration damping devices (e.g., 10, FIGS. 1 to 3B). Sensors 72 can be active in that as device 10 (FIG. 1) creates active forces for canceling vibrations; changes can be detected via sensors 72 and processed at controller 76,

Each FG electrically communicates with central controller 76 via an interface at enclosure (24, FIGS. 1-3B). Controller 76 receives data via sensors 72, and calculates an appropriate force command for each FG. Force commands can be communicated to each FG via communication with the electronics package co-located with vibration damping devices (e.g., via enclosure 24, FIGS. 1-3B). In some aspects, controller 76 can be directly linked to each FG. In other aspects, at least some of the communications (e.g., force commands) between controller 76 and each FG can be wirelessly communicated.

In one embodiment, system 70 includes a plurality of sensors 72, controller 76 electrically communicating with the plurality of sensors 72, and at least one vibration damping device (e.g., one or more FGs). The at least one vibration damping device electrically communicates with controller 76. The vibration damping device includes a housing, an electronics enclosure provided at one end of the housing, multiple electric motors provided within the housing, and a processor within the electronics enclosure for controlling and monitoring an electrical current supplied to the multiple electric motors (see e.g., FIGS. 1-3B). In some aspects, sensors 72 are associated with a mechanical system, and are provided or disposed at a plurality of locations on or throughout the mechanical system. In some aspects, the mechanical system is selected from the group consisting of a rotary aircraft, a propeller-driven aircraft, a jet aircraft, vehicles, engines, transmissions, buildings, structures, industrial equipment, and/or any combination thereof. As described hereinabove, sensors 72 are configured to measure vibration and, in some aspects, include a plurality of accelerometers. Controller 70 is configured to receive vibration data from the sensors 72 and provide a force command to the one or more vibration damping devices (e.g., FGs).

Referring to FIG. 5, a schematic diagram of a tandem rotor aircraft or tandem rotor helicopter, generally designated 80 is shown. Aircraft 80 can comprise multiple rotating rotors R, which can induce complex vibrations within the aircraft. A vibration damping system having a centralized controller 82, one or more sensors 84, and one or more vibration damping devices 86 can be provided in aircraft 80 for canceling or mitigating such complex vibrations. That is, a system similar in form and function to previously described system 70 (FIG. 4) can be provided in aircraft 80.

In the embodiment illustrated in FIG. 5, a plurality of sensors 84 are positioned over portions of the aircraft frame and proximate rotors R. Controller 82 monitor vibrations via sensors 84 and sends force commands to vibration damping devices 86 for generating vibration canceling forces. Vibration damping devices 86 include at least one set of nested imbalance masses and at least one set of side-by-side imbalance masses as described in FIGS. 1-3B. Any two imbalance masses within devices 86 can be configured to rotate in a same direction as previously described. The two remaining imbalance masses can rotate in an opposing direction. Controller 82 monitors the aircraft structural response to vibration damping devices 86 and/or sensors 84.

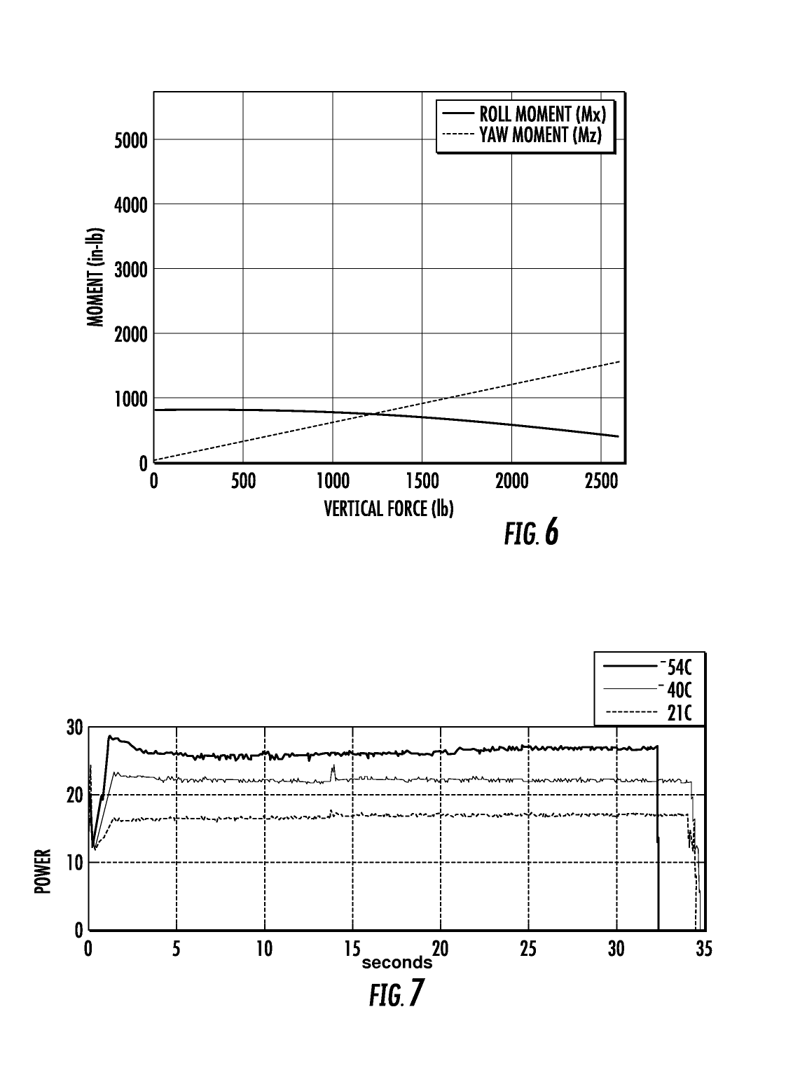

FIGS. 6 and 7 are graphical illustrations of various properties associated with vibration damping devices and systems described herein. FIG. 6 illustrates roll and yaw moments associated with vibration damping devices and/or systems described herein. The roll and yaw moments comprise measurements of airframe stress. The devices described herein can comprise a roll moment that is less than approximately 1000 in-lb. The roll moment can be less than approximately 800 in-lb. This is an improvement by at least a factor of 3 over conventional devices. Devices described herein also comprise a yaw moment of less than approximately 1500 in-lb. This is also an improvement by at least a factor of 3 over conventional devices. The moment introduced by devices and systems described herein is less than a critical roll moment of the rotary aircraft.

FIG. 7 illustrates power consumption over time of devices and/or systems described herein. Devices described herein can start up at approximately −54° C., which has not heretobefore been demonstrated in the conventional state-of-the-art devices. In addition, devices described herein consume approximately 50% less power than conventional state-of-the-art devices. In FIG. 7, power (in Watts (W)) is plotted as a function of time (in seconds). In some aspects, an average startup power at −54° C. is approximately 27 W (or between approximately 20 and 30 W); an average start up power at −40° C. is approximately 24 W (or between 20 and 30 W); and an average power at 21° C. is approximately 15 W (or between 10 and 20 W) as shown in FIG. 7.

Vibration damping devices, systems, and related methods described herein can comprise a design utilizing at least one pair of side-by-side imbalance masses either alone in combination with at least one pair of nested imbalance masses. Any two of the imbalance masses can rotate in a same direction to minimize, cancel, and/or eliminate vibration within an aircraft, such as a rotary winged aircraft. Devices, systems, and related methods described herein are advantageous as they require less power, smaller bearings, increased wear resistance, and can be manufactured at a lower cost. Embodiments as described herein may provide one or more of the following beneficial technical effects: reduced production cost; improved ease of installation; reduced weight; improved vibration control; active vibration control; reduced wear/fatigue issues due to press fit bearings; lower drag torque; improved position control; balancing lower moments; reduced dimensions; increased force density at a smaller footprint; lower power; elimination of encoder; improved EMI; and/or reduced shielding.

While the present subject matter has been has been described herein in reference to specific aspects, features, and illustrative embodiments, it will be appreciated that the utility of the subject matter herein is not thus limited, but rather extends to and encompasses numerous other variations, modifications and alternative embodiments, as will suggest themselves to those of ordinary skill in the field of the present subject matter, based on the disclosure herein. Various combinations and sub-combinations of the structures and features described herein are contemplated and will be apparent to a skilled person having knowledge of this disclosure. Any of the various features and elements as described herein may be combined with one or more other disclosed features and elements unless indicated to the contrary herein. Correspondingly, the subject matter herein as hereinafter claimed is intended to be broadly construed and interpreted, as including all such variations, modifications and alternative embodiments, within its scope and including equivalents of the claims.

What is claimed is:

1. A vibration damping device, the device comprising:
a housing;
at least two imbalance masses provided in a side-by-side configuration within the housing; and
at least two more imbalance masses provided in a nested configuration within the housing;
wherein any two imbalance masses within the housing are paired to rotate together in a same direction according to a desired vibration canceling force.

2. The vibration damping device according to claim 1, wherein the imbalance masses in the nested configuration are disposed about portions of the imbalance masses in the side-by-side configuration.

3. The vibration damping device according to claim 1, wherein the device further comprises a plurality of bearings and a shaft, wherein the shaft and the bearings are steel or aluminum bearings.

4. The vibration damping device according to claim 3, wherein the device further comprises a shaft constructed of the same material as the bearings.

5. The vibration damping device according to claim 1, wherein the device further comprises at least one Hall sensor disposed proximate the shaft.

6. The vibration damping device according to claim 1, wherein the device is encoderless.

7. The vibration damping device according to claim 1, further comprising an electronics enclosure including a processor.

8. The vibration damping device according to claim 7, wherein the electronics enclosure includes a communications input, a communications output, and a power interface.

9. The vibration damping device according to claim 7, wherein the processor is configured to monitor an electrical current provided to one or more drive motors.

10. The vibration damping device according to claim 7, wherein the processor is configured to monitor changes in electrical current provided to one or more drive motors.

11. The vibration damping device according to claim 8, wherein components within the electronics enclosure electrically communicate with components within the housing.

12. The vibration damping device according to claim 1, comprising two side-by-side circular force generators (CFGs).

13. The vibration damping device according to claim 1, wherein a resultant force generated by the device is a linear force.

14. A vibration damping system for use in an aircraft, the system comprising:
a plurality of sensors disposed within a plurality of locations about the aircraft for measuring vibration data;
a controller electrically communicating with the plurality of sensors receiving the vibration data and sending a force command to a vibration damping device; and
the vibration damping device electrically communicating with the controller, wherein the vibration damping device includes:
a housing;
an electronics enclosure provided at one end of the housing;
multiple electric motors provided within the housing; and
a processor disposed within the electronics enclosure for controlling and monitoring an electrical current supplied to the multiple electric motors.

15. The vibration damping system according to claim 14, wherein the vibration damping device further comprises at least two imbalance masses provided in a side-by-side configuration within the housing.

16. The vibration damping system according to claim 15, wherein the vibration damping device further comprises at least two more imbalance masses provided in a nested configuration within the housing.

17. The vibration damping system according to claim 14, wherein the vibration damping device further comprises a plurality of imbalance masses disposed within the housing, and any two imbalance masses of the plurality of imbalance masses paired to rotate together in a same direction according to a desired vibration canceling force.

18. The vibration damping system according to claim 14, wherein the vibration damping device further comprises a plurality of rotors.

19. The vibration damping system according to claim 14, wherein the vibration damping device further comprises a plurality of drive motors.

20. The vibration damping system according to claim 14, wherein electronics enclosure provides electromagnetic interference (EMI) protection of components housed within the electronics enclosure.

21. The vibration damping system according to claim 14, wherein components within the electronics enclosure electrically communicate with components within the housing.

22. The vibration damping system according to claim 14, wherein the plurality of sensors comprises a plurality of accelerometers.

23. The vibration damping system according to claim 14, wherein the electronics enclosure is configured to receive wireless communications from the controller.

24. The vibration damping system according to claim 14, wherein the controller is directly linked to the electronics enclosure.

25. The vibration damping system according to claim 14, wherein the vibration damping device generates a linear force.

26. The vibration damping system according to claim 14, wherein the vibration damping device generates a roll moment that is less than 1000 in-lb.

27. The vibration damping system according to claim 14, wherein the vibration damping device generates a yaw moment that is less than 2000 in-lb.

28. The vibration damping system according to claim 14, wherein the system is operable at −54° C.

29. An tandem rotor helicopter comprising a system according to claim 14.

30. A method of damping vibration within an aircraft, the method comprising steps of:
detecting vibration within the aircraft;
generating and sending a force command to multiple force generators, wherein each force generator includes:
a housing;
at least two imbalance masses provided in a side-by-side configuration within the housing: and
at least two imbalance masses provided in a nested configuration within the housing; and
rotating any two imbalance masses within the housing in a same direction about a shaft to counteract the vibration within the aircraft.

31. The method according to claim 30, wherein the step of detecting vibration within the aircraft further comprises the step of measuring the vibration with a plurality of accelerometers.

32. The method according to claim 30, wherein the step of rotating any two imbalance masses is controlled by a processor disposed in an electronics enclosure of each force generator.

33. The method according to claim 30, further comprising the step of generating a linear force.

34. The method according to claim 30, further comprising the step of generating a roll moment that is less than 1000 in-lb.

35. The method according to claim 30, further comprising the step of generating a yaw moment that is less than 2000 in-lb.

36. The method according to claim 30, wherein rotating any two imbalance masses further comprise the step of transmitting power from a portion of the aircraft to at least one drive motor via a power interface.

37. A vibration damping system, the system comprising:
a plurality of sensors;
a controller electrically communicating with the plurality of sensors; and
a vibration damping device electrically communicating with the controller, wherein the vibration damping device includes:
a housing;
an electronics enclosure provided at one end of the housing;
multiple electric motors provided within the housing; and
a processor disposed within the electronics enclosure for controlling and monitoring an electrical current supplied to the multiple electric motors.

38. The vibration damping system of claim 37, wherein the vibration damping device further comprises at least two imbalance masses provided in a side-by-side configuration within the housing.

39. The vibration damping system of claim 37, wherein the sensors are associated with a mechanical system and are disposed at a plurality of locations on the mechanical system.

40. The vibration damping system of claim 39, wherein the sensors are configured to measure vibration.

41. The vibration damping system according to claim 40, wherein the plurality of sensors comprises a plurality of accelerometers.

42. The vibration damping system of claim 40, wherein the controller is configured to receive vibration data from the sensors and provide a force command to the vibration damping device.

43. The vibration damping system of claim 39, where in the mechanical system is selected from the group consisting of rotary aircraft, propeller-driven aircraft, jet aircraft, vehicles, engines, transmissions, buildings, structures, industrial equipment and combinations thereof.

44. The vibration damping system of claim 39, wherein the vibration damping device comprises at least two more imbalance masses provided in a nested configuration within the housing.

45. The vibration damping system of claim 37, wherein the vibration damping device comprises a plurality of imbalance masse disposed within the housing, and any two imbalance masses of the plurality of imbalance masses paired to rotate together in a same direction according to a desired vibration canceling force.

46. The vibration damping system of claim 43, wherein the vibration damping device further comprises a plurality of rotors and a plurality of drive motors.

47. The vibration damping system according to claim 37, wherein the electronics enclosure is configured to receive wireless communications from the controller.

48. The vibration damping system according to claim 37, wherein the controller is directly linked to the electronics enclosure.

49. The vibration damping system according to claim 37, wherein the vibration damping device generates a linear force.
